(19) United States
(12) Patent Application Publication
(10) Pub. No.: US 2014/0367057 A1
(43) Pub. Date: Dec. 18, 2014

(54) SYSTEM AND METHOD FOR CALIBRATING AND SYCHRONIZING MOVEMENT OF A PLURALITY OF ROLLER SHADES

(71) Applicant: Crestron Electronics, Inc., Rockleigh, NJ (US)

(72) Inventor: George Feldstein, Cresskill, NJ (US)

(73) Assignee: Crestron Electronics, Inc., Rockleigh, NJ (US)

(21) Appl. No.: 14/308,212

(22) Filed: Jun. 18, 2014

Related U.S. Application Data
(60) Provisional application No. 61/836,428, filed on Jun. 18, 2013.

(51) Int. Cl. E06B 9/68

(52) U.S. Cl. CPC E06B 9/68; E06B 2009/6809
USPC 160/405

(57) ABSTRACT

Presented is a method of calibrating and synchronizing movement of at least two roller shades with respect to each other. One of the roller shades is designated as a reference shade and the other as a slave shade. The total number of encoder counts required to move each of the roller shades from fully open to a fully closed is determined. A correction factor for the slave shade is calculated and used to correct the error in the position of the slave shade relative to the reference shade caused by variation in the length of flexible shade material wound around each of the roller shades. The reference shade is moved a desired number of encoder counts in a predetermined amount of time. Simultaneously, the slave shade is moved a corrected number of encoder counts in the same amount of time thereby correcting errors in the rotation rate.

### BACKGROUND OF THE INVENTION

1. Technical Field

The present disclosure relates generally to roller shades, and more particularly to a system and method for calibrating and synchronizing movement of two or more roller shades.

2. Background Art

A typical motorized roller shade includes a flexible shade fabric wound onto an elongated roller tube. The roller tube is rotatably supported so that a lower end of the flexible shade fabric, which includes a hembar attached thereto, can be raised or lowered by rotating the roller tube. Typically, the roller tube is rotated by a motorized drive system that includes a stepper motor that rotates the roller tube in increments of encoder counts.

As the roller tube is rotated to raise the hembar, the thickness of the roller tube plus the wound shade material (i.e., combined diameter) increases as more shade material is wound onto the roller tube. As this combined diameter increases, each successive rotation winds a greater amount of shade material around the roller tube than the previous rotation.

If the combined diameter differs between two shades (i.e., one roller tube starts out with more shade material wrapped therearound than the other roller tube), the hembar of the shade with the larger combined diameter will rise faster (i.e., require less encoder counts to rotate the roller tube) than the hembar of the shade with the smaller combined diameter. Likewise, the hembar of the shade with the larger combined diameter will lower faster (i.e., require less encoder counts to rotate the roller tube) than the hembar of the shade with the smaller combined diameter. In other words, the shades will not track correctly.

Thus, there exists need for a system and method to correctly position and synchronously move two or more roller shades in the same room when the length of the flexible shade material wound around each of the two or more roller shades is different from the length of flexible shade material wound around the other of the two or more roller shades.

### SUMMARY OF THE INVENTION

It is to be understood that both the general and detailed descriptions that follow are exemplary and explanatory only and are not restrictive of the invention

### Disclosure of the Invention

According to one aspect, the invention involves a method of calibrating the position of at least two roller shades with respect to each other to correct errors in position caused by a difference in the length of flexible shade material wound around each of the at least two roller shades. The method includes designating one of the at least two roller shades as a reference shade and designating the other of the at least two roller shades as a slave shade. The method further includes determining an associated total number of encoder counts required to move each of the respective at least two roller shades from a fully open position to a fully closed position. The method further includes calculating a correction factor for the slave shade using the associated total number of encoder counts required to move each of the respective at least two roller shades from the fully open position to the fully closed position. The method further includes using the correction factor to correct the error in the position of the slave shade relative to the reference shade caused by the difference in the length of flexible shade material wound around each of the at least two roller shades.

In one embodiment, using the correction factor to correct the error in the position of the slave shade relative to the reference shade includes multiplying the correction factor and an encoder count corresponding the reference shade position to obtain a corrected encoder count corresponding to a matching slave shade position and moving the slave shade to the corrected encoder count.

In another embodiment, the correction factor for the slave shade is the ratio of the total number of encoder counts required to move the slave shade from the fully open position to the fully closed position to the total number of encoder counts required to move the master shade from the fully open position to the fully closed position.

In another aspect, the invention involves a method of synchronizing movement of at least two roller shades with respect to each other to correct errors in position and rotation rate caused by a difference in the length of flexible shade material wound around each of the at least two roller shades. The method includes designating one of the at least two roller shades as a reference shade and designating the other of the at least two roller shades as a slave shade. The method further includes determining an associated total number of encoder counts required to move each of the respective at least two roller shades from a fully open position to a fully closed position. The method further includes calculating a correction factor for the slave shade using the associated total number of encoder counts required to move each of the respective at least two roller shades from the fully open position to the fully closed position. The method further includes using the correction factor to correct the error in the position of the slave shade relative to the reference shade caused by the difference in the length of flexible shade material wound around each of the at least two roller shades. The method further includes moving the reference shade a desired number of encoder counts in a predetermined amount of time and simultaneous with moving the reference shade, moving the slave shade a corrected number of encoder counts in the predetermined amount of time thereby correcting errors in the rotation rate caused by the difference in the length of flexible shade material wound around each of the at least two roller shades. The corrected number of encoder counts is obtained by multiplying the correction factor and the desired number of encoder counts.

In one embodiment, using the correction factor to correct the error in the position of the slave shade relative to the reference shade includes multiplying the correction factor and an encoder count corresponding the reference shade position to obtain a corrected encoder count corresponding to a matching slave shade position and moving the slave shade to the corrected encoder count.

In another embodiment, the correction factor for the slave shade is the ratio of the total number of encoder counts required to move the slave shade from the fully open position to the fully closed position to the total number of encoder counts required to move the master shade from the fully open position to the fully closed position.

### BRIEF DESCRIPTION OF THE DRAWINGS

The accompanying figures further illustrate the present invention. Exemplary embodiments are illustrated in reference figures of the drawings. It is intended that the embodiments and figures disclosed herein are to be considered to illustrative rather than limiting.

The components in the drawings are not necessarily drawn to scale, emphasis instead being placed upon clearly illustrating the principles of the present invention. In the drawings, like reference numerals designate corresponding parts throughout the several views.

FIG. 1 is an illustrative block diagram of shade system, according to one embodiment of the invention.

FIG. 2 is an illustrative front view of two fully closed (i.e., lowered) roller shades each mounted in a window frame, according to one embodiment of the invention.

FIG. 3 is an illustrative front view of two half open roller shades each mounted in a window frame, according to one embodiment of the invention.

FIG. 4 is an illustrative front view of two fully open (i.e., raised) roller shades each mounted in a window frame, according to one embodiment of the invention.

FIG. 5 is an illustrative flow diagram of the step for calibrating and synchronizing movement of at least two roller shades, according to one embodiment of the invention.

### LIST OF REFERENCE NUMBERS FOR THE MAJOR ELEMENTS IN THE DRAWING

The following is a list of the major elements in the drawings in numerical order.
102a roller shade
102b roller shade
104a roller tube
104b roller tube
106a flexible shade material
106b flexible shade material
108a hembar
108b hembar
110a motor
110b motor
112a motor controller
112b motor controller
114a memory
114b memory
116a controller interface
116b controller interface
118a microcontroller
118b microcontroller
120a motor driver circuit
120b motor driver circuit
130 master controller
202a window frame
202b window frame
502 designate master shade
504 designate slave shade
506 determine the total number of encoder counts to move each shade from fully open to fully closed
508 calculate a correction factor for the slave shade
510 correct the position and rate of movement of the slave shade using the calculated correction factor

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### MODE(S) FOR CARRYING OUT THE INVENTION

Disclosed are a system and a method for calibrating position and synchronizing movement of at least two roller shades, where the length/amount of flexible shade material wound around one of the at least two roller shade roller tubes is different from the length/amount of flexible shade material wound around the other of the at least two roller shade roller tubes.

More specifically, the disclosed system and method involves calibrating shade position and controlling/synchronizing each shade motor's rotation rate to correct errors in the position and movement (rotation rate of the shade motors) of the at least two roller shades relative to each other caused by the difference between the length/amount of flexible shade material wound around one of the at least two roller shade roller tubes and the length/amount of flexible shade material wound around the other of the at least two roller shade roller tubes.

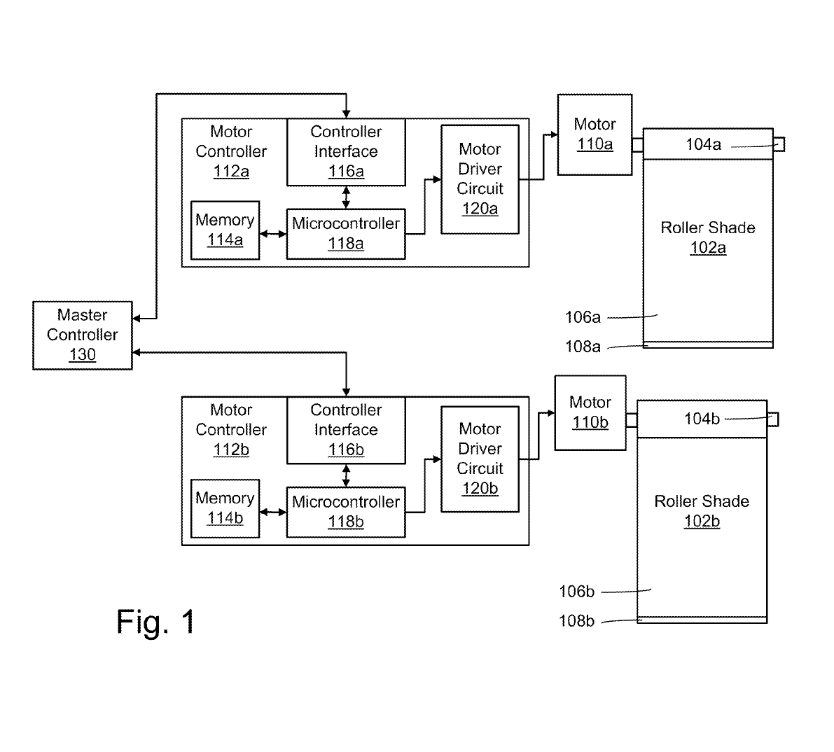

Referring to FIG. 1, in one embodiment, the roller shade system includes at least two roller shades 102a, 102b and associated shade motors 110a, 110b each controlled by shade motor controllers 112a, 112b, respectively. The two roller shades 102a, 102b each include respective roller tubes with flexible shade material wound therearound. The shade motor controllers 112a, 112b are controlled by master controller 130.

The shade motor controller 112a includes a microcontroller 118a, nonvolatile memory 114a, motor drive circuit 120a, and wired or wireless control interface circuitry 116a, such as Ethernet, IR, or RF circuitry.

The shade motor controller 112b includes a microcontroller 118b, nonvolatile memory 114b, motor drive circuit 120b, and wired or wireless control interface circuitry 116b, such as Ethernet, IR, or RF circuitry.

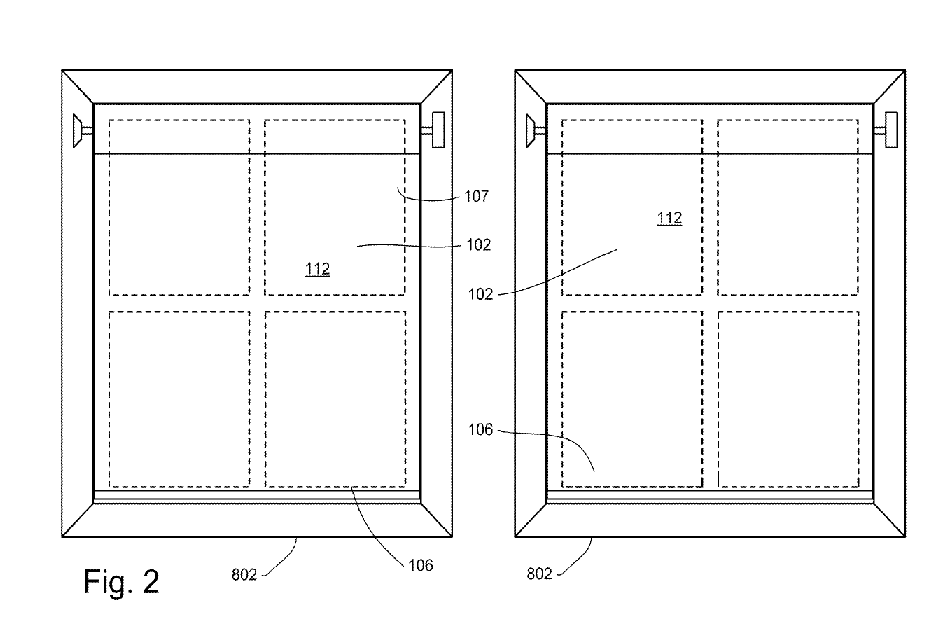

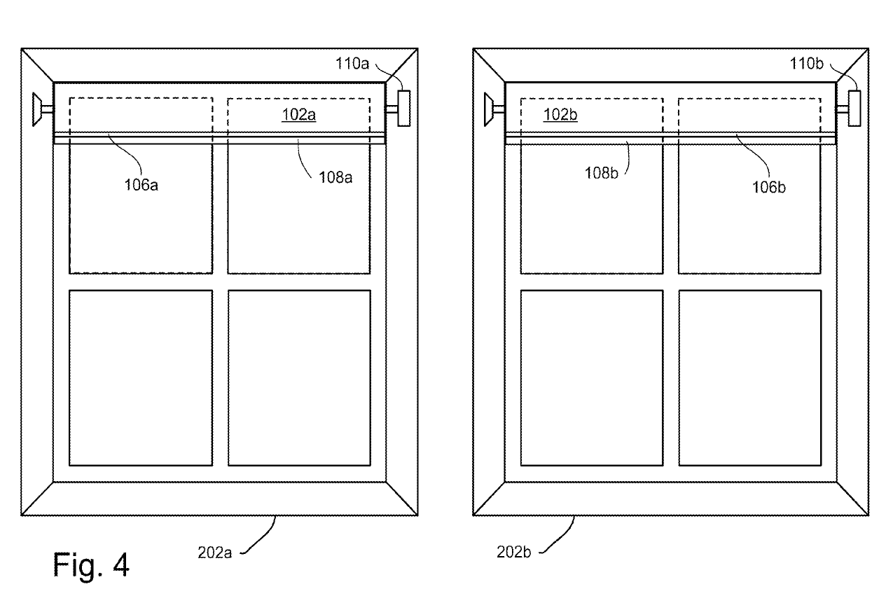

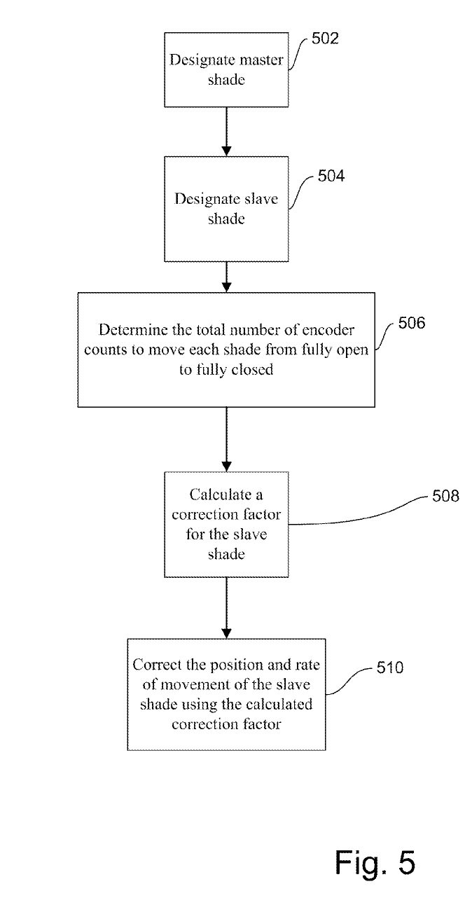

Referring to FIG. 5, according to one embodiment, one roller shade of the plurality of roller shades is chosen or designated as a master or reference shade (Step 502) and the remaining one or more roller shades are designated as slave shades (Step 504). For each of the plurality of roller shades, the total number of encoder counts needed to move the particular shade from fully open (see FIG. 4) to fully closed (see FIG. 2) is determined (Step 506). The total number of encoder counts for the reference shade and the total number of encoder counts for a particular slave shade are used to calculate a correction factor for that particular slave shade (Step 508). Each calculated correction factor is used to correct the position and rate of movement for the associated slave shade as compared to the reference shade (Step 510).

The correction factor for a shade N is determined using the following equations.

Eₙ=E_{ref}*Kₙ Equation 1

Kₙ=[TC_{ref}+(TCₙ−TC_{ref})]/TC_{ref} (if TCₙ is greater than TC_{ref}) Equation 2

Kₙ=[TC_{ref}−(TC_{ref}−TCₙ)]/TC_{ref} (if TCₙ is less than TC_{ref}) Equation 3

where E_{ref} is the desired position (in encoder counts) of the reference shade; Eₙ is the matching/tracked position of the slave shade N (i.e., slave shade 1, slave shade 2, etc.); Kₙ is the correction factor for slave shade N; TC_{ref} is the total number of encoder counts to fully unroll the reference shade, and TCₙ is the total number of encoder counts to fully unroll the slave shade N.

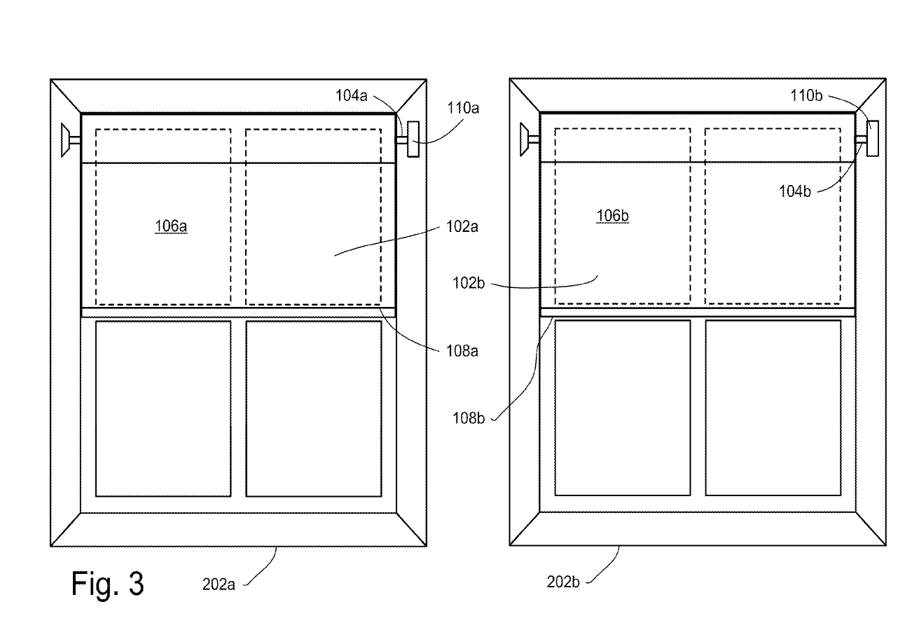

As an example, assume TC_{ref}=10000 encoder counts, and TC₁ (slave shade 1)=10600 encoder counts. In this example, TC₁>TC_{ref} because the flexible shade material of slave shade 1 is longer than the flexible shade material of the reference shade. Next assume that a user wants to move the shades 102a and 102b to a half open position (i.e., 50% open, see FIG. 3). With a conventional shade system, the shade motors 110a and 110b would rotate an equal number of encoder counts to reach the desired position. Because the shades 102a and 102b require different total encoder counts to move from fully open to fully closed, the result would be that the shades 102a and 102b would end up in different final positions, e.g., shade 102a would be 50% open and shade 102b would be less than 50% open, or shade 102b would be 50% open and shade 102a would be more than 50% open.

According to the present disclosure, the master controller 130 would instruct each separate motor controller 112a, 112b, to move the respective associated shade motor 110a, 110b a different number encoder counts using the above equations 1 and 2.

Specifically,
TC_{ref}=10000
TC₁=10600
E_{ref}=5000
K₁=1.06
E₁=E_{ref}*K₁=5000*1.06=5300 encoder counts.

In other words, because slave shade 102b takes 600 encoder counts more than the reference shade 102a to move from fully open to fully closed, the slave shade 102b must be moved 5300 encoder counts to move to 50% open, while the master shade 102a is only moved 5000 encoder counts to move to 50% open. Additionally, both reference shade 102a and slave shade 102b are moved to 50% open by the respective motor controllers 112a and 112b in the same amount of time (e.g., 10 seconds). Consequently, reference shade 102a moves at a rate of 500 encoder counts per second and slave shade 102b moves at a rate of 530 encoder counts per second so that reference shade 102a and slave shade 102b arrive at the same physical position at the same time.

Continuing with the example above, assume a second slave shade with TC₂=9400 encoder counts (i.e., has a shorter length of flexible shade material than the reference shade) also must move to a 50% open position.

According to the present disclosure, the master controller 130 would instruct a motor controller (and shade motor) associated with the second slave shade a different number encoder counts using the above equations 1 and 3.

Specifically,
TC_{ref}=10000
TC₂=9400
E_{ref}=5000
K₂=0.94
E₂=E_{ref}*K₂=5000*0.94=4700 encoder counts.

In other words, because slave shade takes 600 encoder counts less than the reference shade 102a to move from fully open to fully closed, the slave shade must be moved 4700 encoder counts to move to 50% open, while the master shade is moved 5000 encoder counts to move to 50% open. Additionally, both the reference shade and the slave shade are moved to 50% open by the respective motor controllers and in the same amount of time (e.g., 10 seconds). Consequently, the reference shade moves at a rate of 500 encoder counts per second and the slave shade moves at a rate of 470 encoder counts per second so that reference shade and slave shade arrive at the same physical position at the same time.

In various embodiments, during installation, a technician determines TC_{ref} for the reference shade and TCₙ for each slave shade. This is accomplished by the technician first mounting each shade over a window, fully winding each shade around their respective roller tube (i.e., having each shade fully open), and setting each shade motor encoder count to zero. Next, the technician selects one shade as the reference/master shade, leaving the remaining shades to function as slave shades. The technician then unwinds each shade until each window is fully covered (i.e., having each shade fully closed) and recording each shade's motor encoder count. As described above, the motor encoder count for the fully closed reference shade is TC_{ref}. These encoder counts are then stored in a look up table that is stored in a memory in the master controller 130 (or in a memory in each shade motor controller).

In one embodiment, when a user chooses a desired physical position to which the plurality of shades should move, the master controller converts the desired position to a percentage of TC_{ref} (the total number of encoder counts to fully close the reference shade), and assigns this number of encoder counts to E_{ref.} The master controller 130 then uses the values for E_{ref}, TC_{ref}, and each TCₙ to calculate the respective values for Kₙ and Eₙ. Thereafter the master controller 130 transmits the values En to the respective shade motor controllers, which in turn, move the respective slave shade to the desired position in the predetermined time. It should be understood that for the reference shade, Eₙ=E_{ref}.

In other words, the position of the reference shade is equal to the unscaled desired position and the position of each slave shade N is the desired position scaled by the correction factor Kₙ.

In another embodiment, when a user chooses a desired physical position to which the plurality of shades should move, the master controller transmits E_{ref} and TC_{ref} to each slave shade motor controller. Thereafter, each slave shade motor controller users E_{ref}, TC_{ref}, and the associated TCₙ (which is stored in the shade motor controller memory) to calculate the respective values for Kₙ and then Eₙ. After each slave shade motor controller calculates its particular Eₙ, each slave shade motor controller moves the associated shade to the desired position in the predetermined time.

In various embodiments, the roller shades, the shade motors, the shade motor controllers, and the master controller are manufactured using materials and methods known to those skilled in the art.

### ALTERNATE EMBODIMENTS

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method of calibrating the position of at least two roller shades with respect to each other to correct errors in position caused by a difference in the length of flexible shade material wound around each of the at least two roller shades, the method comprising:
designating one of the at least two roller shades as a reference shade;
designating the other of the at least two roller shades as a slave shade;
determining an associated total number of encoder counts required to move each of the respective at least two roller shades from a fully open position to a fully closed position;
calculating a correction factor for the slave shade using the associated total number of encoder counts required to move each of the respective at least two roller shades from the fully open position to the fully closed position; and
using the correction factor to correct the error in the position of the slave shade relative to the reference shade caused by the difference in the length of flexible shade material wound around each of the at least two roller shades.

2. The method of claim 1, wherein using the correction factor to correct the error in the position of the slave shade relative to the reference shade comprises multiplying the correction factor and an encoder count corresponding the reference shade position to obtain a corrected encoder count corresponding to a matching slave shade position and moving the slave shade to the corrected encoder count.

3. The method of claim 1, wherein the correction factor for the slave shade is the ratio of the total number of encoder counts required to move the slave shade from the fully open position to the fully closed position to the total number of encoder counts required to move the master shade from the fully open position to the fully closed position.

4. A method of synchronizing movement of at least two roller shades with respect to each other to correct errors in position and rotation rate caused by a difference in the length of flexible shade material wound around each of the at least two roller shades, the method comprising:
designating one of the at least two roller shades as a reference shade;
designating the other of the at least two roller shades as a slave shade;
determining an associated total number of encoder counts required to move each of the respective at least two roller shades from a fully open position to a fully closed position;
calculating a correction factor for the slave shade using the associated total number of encoder counts required to move each of the respective at least two roller shades from the fully open position to the fully closed position;
using the correction factor to correct the error in the position of the slave shade relative to the reference shade caused by the difference in the length of flexible shade material wound around each of the at least two roller shades;
moving the reference shade a desired number of encoder counts in a predetermined amount of time; and
simultaneous with moving the reference shade, moving the slave shade a corrected number of encoder counts in the predetermined amount of time thereby correcting errors in the rotation rate caused by the difference in the length of flexible shade material wound around each of the at least two roller shades, the corrected number of encoder counts being obtained by multiplying the correction factor and the desired number of encoder counts.

5. The method of claim 4, wherein using the correction factor to correct the error in the position of the slave shade relative to the reference shade comprises multiplying the correction factor and an encoder count corresponding the reference shade position to obtain a corrected encoder count corresponding to a matching slave shade position and moving the slave shade to the corrected encoder count.

6. The method of claim 4, wherein the correction factor for the slave shade is the ratio of the total number of encoder counts required to move the slave shade from the fully open position to the fully closed position to the total number of encoder counts required to move the master shade from the fully open position to the fully closed position.
